(19) United States
(12) Patent Application Publication
(10) Pub. No.: US 2026/0343244 A1
(43) Pub. Date: Oct. 29, 2026

(54) Adversarial learning-based optimization method for collaborative computing services in integrated space-air-ground network

(71) Applicant: NANJING UNIVERSITY OF POSTS AND TELECOMMUNICATIONS, Nanjing (CN)

(72) Inventors: Haitao ZHAO, Nanjing (CN); Bo XU, Nanjing (CN); Jinlong SUN, Nanjing (CN); Miao LIU, Nanjing (CN); Huaicong KONG, Nanjing (CN); Suyao HUANG, Nanjing (CN); Wei XUN, Nanjing (CN); Bangning XU, Nanjing (CN)

(73) Assignee: NANJING UNIVERSITY OF POSTS AND TELECOMMUNICATIONS, Nanjing (CN)

(21) Appl. No.: 19/466,569

(22) Filed: Feb. 2, 2026

Related U.S. Application Data
(63) Continuation of application No. PCT/CN2025/112037, filed on Aug. 1, 2025.

(30) Foreign Application Priority Data
Dec. 3, 2024 (CN) 202411758498.8

(51) Int. Cl. H04W 16/18; G06F 9/50; G06F 30/27; G06F 111/04

(52) U.S. Cl. CPC H04W 16/18; G06F 9/5027; G06F 30/27; G06F 2111/04; G06F 2209/509

(57) ABSTRACT

An adversarial learning-based optimization method for collaborative computing services in an integrated space-air-ground network belongs to the technical fields of artificial intelligence and wireless communication in integrated space-air-ground networks. The method includes: (1) proposing several allocation modes for computing tasks in an edge mobile computing communication system in the integrated space-air-ground network; (2) obtaining total delay and energy consumption experienced by wireless devices under the different allocation modes; (3) proposing an objective function and a constraint condition, and forming an optimization problem based on the objective function and the constraint condition; and (4) finding optimal results through iterations. The method minimizes total system delay, and proposes a generative adversarial network-genetic algorithm to solve nonlinear and highly complex problems more efficiently and accurately, where the generative adversarial network can learn the features and distribution of data, making the generated solutions more realistic and better able to solve practical problems.

### CROSS REFERENCE TO THE RELATED APPLICATIONS

This application is the continuation application of International Application No. PCT/CN2025/112037, filed on Aug. 1, 2025, which is based upon and claims priority to Chinese Patent Application No. 202411758498.8, filed on Dec. 3, 2024, the entire contents of which are incorporated herein by reference.

### TECHNICAL FIELD

The present invention relates to the technical fields of artificial intelligence and wireless communication in integrated space-air-ground networks, and in particular, to an adversarial learning-based optimization method for collaborative computing services in an integrated space-air-ground network.

### BACKGROUND

In integrated space-air-ground scenarios, more and more terminals are equipped with certain computing capabilities, leading to an increasing demand for model computation. However, the computing capability of a single terminal is limited. To optimize resource allocation in an integrated space-air-ground network, closer collaboration between various types of terminals and edge servers is essential. For example, ground wireless devices and nearby unmanned aerial vehicles can be considered for collaborative computing to accelerate the completion of a computing task.

However, in the existing integrated space-air-ground network, the computing task is computed by only a single terminal or two collaborative terminals, while the abundant computing capabilities of other nearby terminal devices and satellites are ignored, making resource allocation relatively difficult.

In view of insufficient edge computing resources in the conventional integrated space-air-ground network, the present invention proposes a resource allocation model for an edge mobile computing communication system, which employs a generative adversarial network-genetic algorithm to obtain an optimal resource allocation strategy.

### SUMMARY

The present invention aims to provide an adversarial learning-based optimization method for collaborative computing services in an integrated space-air-ground network, to solve the problems of difficult resource allocation and the like in the prior art.

The present invention provides an adversarial learning-based optimization method for collaborative computing services in an integrated space-air-ground network, including the following steps:
S1. building an edge mobile computing communication system used for the collaborative computing services in the integrated space-air-ground network, where the edge mobile computing communication system is composed of wireless devices, unmanned aerial vehicles, edge servers, and a little earth orbit (LEO) satellite, where the quantity of the wireless devices is J, a set of the J wireless devices is defined as J={1, 2, . . . , J}, the quantity of the unmanned aerial vehicles is K, a set of the K unmanned aerial vehicles is defined as K={1, 2, . . . , K}, the unmanned aerial vehicle is abbreviated as UAV, the quantity of the edge servers is U, a set of the U edge servers is defined as U={1, 2, . . . , U} the LEO satellite is defined as s, and each of the wireless devices j∈J has a computing task Mⱼ; proposing several allocation modes for the computing tasks, and obtaining offloading waiting delay and transmission energy consumption for the computing tasks under the different allocation modes based on the edge mobile computing communication system;
S2. obtaining total delay and energy consumption experienced by the wireless devices under the different allocation modes based on the edge mobile computing communication system;
S3. building a resource allocation model for the edge mobile computing communication system, proposing an objective function and a constraint condition, and forming an optimization problem based on the objective function and the constraint condition;
where energy constraints of the wireless device and the unmanned aerial vehicle are respectively

$${E}_{j}^{max} and {E}_{k}^{max} ,$$

an optimization objective is defined as

$${minimize}_{w} {\sum }_{j ∈ J} {T}_{j}$$

to minimize the total delay experienced by the wireless device while satisfying the energy constraints of the wireless device j and the unmanned aerial vehicle k;
where w represents a binary variable of an association strategy, and Tⱼ represents the total delay experienced by the wireless device j;
the constraint condition for the energy constraints of the wireless device j and the unmanned aerial vehicle k includes:

$${E}_{j}^{loc} + {E}_{j}^{k} + {E}_{j}^{u} \leq {E}_{j}^{max} , {\sum }_{j ∈ J} {\overline{w}}_{j}^{k} {E}_{j}^{k , comp} + {\sum }_{{k}^{′} ∈ K , {k}^{′} \neq k} {E}_{j}^{k \to {k}^{′}} + {E}^{k \to s} + {E}_{k}^{h o v} \leq {E}_{k}^{max} , ∀ k ∈ K ;$$

where

$${E}_{j}^{u}$$

represents energy consumption for task offloading from the wireless device j to the edge server u,

$${E}_{j}^{k}$$

represents energy consumption for task offloading from the wireless device j to UAV^{k}, E^{k→k′} represents energy consumption for task offloading from UAV^{k} to UAV^{k′}. E^{k→s} represents energy consumption for task offloading from UAV^{k} to the satellite s,

$${E}_{k}^{hov}$$

represents energy consumption for hovering of the unmanned aerial vehicle, and

$${E}_{j}^{k , comp}$$

represents energy consumption when UAV^{k} performs the computing task Mⱼ;
S4. performing the following operations:
S41. building a generative adversarial network by using a generative adversarial network-genetic algorithm (GAN-GA) algorithm to achieve minimal total system delay;
S42. defining an evaluation function based on the objective of minimal total system delay to compute a performance indicator and fitness;
S43. selecting next-generation parent solutions and optimal solutions of a population by elite selection and roulette selection based on the fitness;
S44. initializing first-generation parent solutions, starting evolution, using a generator for the generative adversarial network to replace conventional crossover and mutation operations in a genetic algorithm, and selecting the next-generation parent solutions; and
S45. finding optimal results through iterations.

Preferably, S1 specifically includes the following steps:
S11. acquiring data from the wireless devices, the unmanned aerial vehicles, the satellite, and the edge servers in the edge mobile computing communication system, where

each wireless device j∈J in the considered network has a computing task Mⱼ, represented by Mⱼ=αⱼ+Aⱼ, where αⱼ a central processing unit (CPU) cycle required to process one bit of data, and Aⱼ represents a total input data size of the task;
S12. building task offloading decision variables to represent whether the computing task of the wireless device is completed locally or collaboratively computed with other terminals and servers, including:
1. if the computing task Mⱼ is compute in the wireless device j that the computing task Mⱼ is computed only locally:

$${w}_{j}^{loc} = \{ \begin{matrix}1 , \text{?} {M}_{j} \text{?} j \text{?} \\ 0 , otherwise\end{matrix}$$

1. if the computing task Mⱼ of the wireless device j is offloaded to the edge server u computing task Mⱼ is offloaded to the edge server u:

$${{w}^{⌢}}_{j}^{u} = \{ \begin{matrix}1 , \text{?} {M}_{j} \text{?} u \\ 0 , otherwise .\end{matrix}$$

1. if the computing task Mⱼ of the wireless device j is offloaded to the UAV^{k} the computing task Mⱼ is offloaded to the UAV k:

$${\overline{w}}_{j}^{k} = \{ \begin{matrix}1 , \text{?} {M}_{j} \text{?} UAVk \\ 0 , otherwise .\end{matrix}$$

1. if the computing task Mⱼ is offloaded from UAV^{k} to UAV^{k′} ent whether computing task Mⱼ is offloaded from the UAV k to UAV k′, where the UAV k′ is nearest the UAV k:

$${\tilde{w}}_{j}^{k \to {k}^{′}} = \{ \begin{matrix}1 , \text{?} {M}_{j} \text{?} UAVk \text{?} {UAVk}^{′} \\ 0 , otherwise\end{matrix}$$

1. if the computing task Mⱼ is offloaded from the UAV^{k} to the satellite the UAV k offloads the task to the satellite s:

$${\hat{w}}_{j}^{k \to s} = \{ \begin{matrix}1 , \text{?} {M}_{j} \text{?} UAVk \text{?} \\ 0 , otherwise\end{matrix}$$

S13. computing offloading waiting delay and transmission energy consumption for the computing tasks under different allocation modes in the edge mobile computing communication system based on the data from the wireless devices, the unmanned aerial vehicles, the satellite, and the edge servers, where
the communication rate from the wireless device j to the edge server u is

$${R}_{j}^{u} ,$$

the transmission delay experienced by the wireless device j when offloading its computing task to the edge server u is

$${t}_{j}^{u} = \frac{{A}_{j}}{{R}_{j}^{u}} ,$$

and the energy consumption for task offloading from the wireless device j to the edge server u is

$${E}_{j}^{u} = \frac{{P}_{j} {A}_{j}}{{R}_{j}^{u}} ;$$

where Pⱼ represents an uplink transmission power of the wireless device j;
the communication rate from the wireless device j to the UAV k is

$${R}_{j}^{k} ,$$

the transmission delay experienced by the wireless device j when offloading its computing task to the UAV k is

$${t}_{j}^{k} = \frac{{A}_{j}}{{R}_{j}^{k}} ,$$

and the energy consumption for task offloading from the wireless device j to the UAV k is

$${E}_{j}^{k} = \frac{{P}_{j} {A}_{j}}{{R}_{j}^{k}} ;$$

the communication rate from the UAV k to the UAV k′ is R^{k→k′}, the transmission delay between the UAV k and the UAV k′ is

$${t}_{j}^{k \to {k}^{′}} = \frac{{\sum }_{j ∈ {J}_{k}} {\tilde{w}}_{j}^{k \to {k}^{′}} {A}_{j}}{{R}^{k \to {k}^{′}}} ,$$

and the energy consumption for task offloading from the UAV k to the UAV k′ is

$${E}_{j}^{k} = \frac{{P}_{j} {A}_{j}}{{R}_{j}^{k}} ,$$

where P^{k→k′} represents an uplink transmission power from the UAV k to the UAV k′, and Jₖ represents a total set of wireless devices for collaborative computing between the wireless device j and the UAV k;
the communication rate from the UAV k to the satellite is R^{k→s}, the transmission delay between the UAV k and the satellite is

$${t}_{j}^{k \to s} = \frac{{\sum }_{j ∈ {J}_{k}} {\hat{w}}_{j}^{k \to s} {A}_{j}}{{R}^{k \to s}} ,$$

and the energy consumption for task offloading from the UAV k to the satellite is

$${E}^{k \to s} = {P}^{k \to s} ( \frac{{\sum }_{j ∈ {J}_{k}} {\hat{w}}_{j}^{k \to s} {A}_{j}}{{R}^{k \to s}} ) ,$$

where P^{k→s} represents an uplink transmission power from the UAV k to the satellite.

Preferably, S2 is specifically as follows:
if the wireless device ∀j∈J decides to perform its computing task locally

$$( i . e . , {w}_{j}^{l o c} = 0 ) ,$$

the delay experienced by the wireless device to complete the task is as follows:

$${t}_{j}^{loc} = \frac{{α}_{j} {A}_{j}}{{F}_{j}} , ∀ j ∈ J$$

where Fⱼ represents a computing power of the wireless device j (i.e., cycle/s); the local energy consumption of the wireless device j is expressed as follows:

$${E}_{j}^{loc} = {{ϖ}_{j} ( {F}_{j} )}^{2} {α}_{j} {A}_{j} , j ∈ J$$

where ω̅ⱼ represents a constant that depends on a chip architecture of the wireless device;
when

$${{w}^{}}_{j}^{u} = 1 ,$$

the time required for the edge server u to complete the computing task is as follows:

$${t}_{j}^{u , c o m p} = \frac{{α}_{j} {A}_{j}}{{f}_{j}^{u}} , ∀ j ∈ {J}_{u}$$

where γⱼ represents a CPU cycle required to process one bit of data, and

$${f}_{j}^{u}$$

represents computing resources allocated to the edge server u of the wireless device j, formulated by a weighted proportional allocation formula as follows:

$${f}_{j}^{u} = {F}_{u}^{max} \frac{{α}_{j} {A}_{j}}{{\sum }_{∀ j ∈ J} {{w}^{}}_{j}^{u} {α}_{j} {A}_{j}} , ∀ j ∈ {J}_{u}$$

where

$${F}_{u}^{max}$$

represents a maximum computing power at the edge server u; the delay experienced by the wireless device j and the edge server u to collaboratively complete the computing task is as follows:

$${t}_{j}^{j , u} = {t}_{j}^{j \to u} + {t}_{j}^{u , c o m p} , ∀ j ∈ {J}_{u}$$

if the task of the wireless device j is computed at the UAV k, the time required for the UAV k to complete the computing task is as follows:

$${t}_{j}^{k , loc} = \frac{{α}_{j} {A}_{j}}{{f}_{j}^{k}} , ∀ k ∈ K , {∀}_{J} ∈ {J}_{k}$$

where

$${f}_{j}^{k}$$

represents a computing power of the UAV k that is allocated to the wireless device j, formulated by a weighted proportional allocation formula as follows:

$${f}_{j}^{k} = {F}_{k}^{max} \frac{{α}_{j} {A}_{j}}{{\sum }_{∀ j ∈ J} {\overline{w}}_{j}^{k} {α}_{j} {A}_{j}} , ∀ k ∈ K , ∀ j ∈ {J}_{k}$$

where

$${F}_{k}^{max}$$

represents a maximum computing power at the UAV k; therefore, when

$${\overline{w}}_{j}^{k} = 1 ,$$

the total delay experienced by the wireless device j is expressed as follows:

$${t}_{j}^{k , e} = {t}_{j}^{k} + {t}_{j}^{k , comp} , ∀ k ∈ K , ∀ j ∈ {J}_{k}$$

when

$${\tilde{w}}_{j}^{k \to {k}^{′}} = 1 ,$$

the total delay experienced by the wireless device j is expressed as follows:

$${t}_{j}^{k , e} = {t}_{j}^{k} + {t}_{j}^{k \to {k}^{′}} + {t}_{j}^{k , comp} , ∀ k ∈ K , ∀ j ∈ {J}_{k}$$

the energy consumption at the UAV k to perform the computing task Tⱼ is formulated as follows:

$${E}_{j}^{k , comp} = {{ϖ}_{k} ( {f}_{j}^{k} )}^{2} {α}_{j} {A}_{j} , ∀ j ∈ J , ∀ k ∈ K ,$$

when the computing task of the wireless device j associated with the UAV k is completed on the satellite, the satellite has renewable energy, and the computational energy consumption of the satellite is ignored; when the computing task of the wireless device j is offloaded to the satellite, the total execution delay experienced by the wireless device j is

$${l}_{j}^{k \to s , e} = {l}_{j}^{k} + {l}_{j}^{k \to s} + {l}_{j}^{s , comp} + 2 {l}_{j}^{k \to s , pro} , ∀ j ∈ {J}_{k} , k ∈ K , where {t}_{j}^{k \to s , pro} = \frac{{d}_{k}^{s}}{c}$$

represents propagation delay between the UAV k and the satellite.

Preferably, S3 is specifically as follows:

$${w}_{j}^{loc} + {\overline{w}}_{j}^{k} + {{w}^{︵}}_{j}^{u} + {\tilde{w}}_{j}^{k \to {k}^{′}} + {\hat{w}}_{j}^{k \to s} = 1 , ∀ j ∈ J$$

represents that the wireless device can select only one collaborative computing mode;

$${w}_{j}^{loc} , {{w}^{︵}}_{j}^{u} , {\overline{w}}_{j}^{k} , {\tilde{w}}_{j}^{k \to {k}^{′}} , {\hat{w}}_{j}^{k \to s} ∈ \{ 0 , 1 \} , ∀ j , {j}^{′} ∈ J ,$$

∀k∈K, u∈U represents a binary decision variable of the wireless device;

$${E}_{j}^{u}$$

represents energy consumption for task offloading from the wireless device j to the edge server u,

$${E}_{j}^{k}$$

represents energy consumption for task offloading from the wireless device j to the UAV k, E^{k→k′} represents energy consumption for task offloading from the UAV k to the UAV k′, E^{k→s} represents energy consumption for task offloading from the UAV k to the satellite s,

$${E}_{k}^{hov}$$

represents energy consumption for hovering of the unmanned aerial vehicle, and

$${E}_{j}^{k , comp}$$

represents energy consumption when the UAV k performs the computing task Mⱼ.

Preferably, in S4,
S41 is specifically as follows:
the GAN trains a generator and a discriminator, and the generator and the discriminator participate in a zero-sum game to generate real samples;
the generator, with a function representation G(z), uses a random noise vector z sampled from distributed P_{z} as input and maps z to a data space, i.e., z~P_{z}(z);
the discriminator, as a binary classifier and with a function representation D(x), receives actual data x and the generated result G(z) as input; the discriminator strives to make the output D(G(z)) close to 0 and the output D(x) close to 1;
an objective function of the discriminator is formulated as follows:

$${min}_{G} {max}_{D} {E}_{x \sim {P}_{data}} [ log ( D ( x ) ) ] + {E}_{x \sim {P}_{z}} [ log ( 1 - D ( G ( z ) ) ) ]$$

where x~P_{data} represents the distribution of real data; through iterative training of the generator and the discriminator, when the discriminator fails to distinguish the real data and the generated results, the generator has successfully fooled the discriminator, and the generated results are closely consistent with the distribution of real data;
S42 is specifically as follows:
the evaluation function performs a series of complex computations on input sample features and generates an evaluation result;
the fitness function accepts the evaluation result of the evaluation function; considering the given population j∈{1, 2, . . . , J}, the result value of the individual j that is generated by the evaluation function is Tⱼ; in the context of minimization problem, the fitness function is expressed as follows:

Oⱼ=Tₘₐₓ−Tⱼ+τ
where τ represents a very small real number used to ensure Oⱼ>0, and Tₘₐₓ represents a maximum tolerable delay of the task;
S43 specifically includes:
sorting the individuals according to the fitness function, selecting the top 20% individuals with the highest fitness as elite individuals, and determining selection probabilities of the remaining individuals based on their proportions of fitness in the population;
randomly selecting the remaining individuals based on their probabilities to fill remaining selection gaps; and
merging the elite individuals with the individuals selected by roulette, and returning the selected next-generation parent solutions, indexes of the optimal solutions of the population, the fitness of the optimal solutions of the population, and the fitness of all the selected individuals;
S44 specifically includes:
initializing a parent population;
performing iterations, where each iteration includes the following steps:
generating offspring by using GAN,
merging the offspring with the parents,
decoding the merged population, that is, converting floating-point code into actual parameter values,
evaluating the performance of each individual, and
computing fitness; and
performing a selection operation to select a next-generation parent population, and recording optimal solutions and average solutions of the current generation;
where in each iteration, the GAN accepts the current parent population as input and generates a new offspring population.

Compared with the prior art, the present invention adopts the above technical solutions to achieve the following technical effects:
(1) The method minimizes total system delay; and
(2) The method proposes the generative adversarial network-genetic algorithm to solve nonlinear and highly complex problems more efficiently and accurately, where the generative adversarial network can learn the features and distribution of data, making the generated solutions more realistic and better able to solve practical problems.

### BRIEF DESCRIPTION OF THE DRAWINGS

FIG. 1 is an architecture diagram of an integrated space-air-ground collaborative computing network; and

FIG. 2 is a flowchart of an adversarial learning-based optimization method for collaborative computing services in an integrated space-air-ground network.

### DETAILED DESCRIPTION OF THE EMBODIMENTS

Technical solutions in embodiments of the present invention will be clearly and completely described below. Apparently, the described embodiments are merely some embodiments of the present invention, not all of them. Based on the embodiments of the present invention, all other embodiments obtained by those of ordinary skill in the art without any creative efforts shall fall within the scope of protection of the present invention. Experimental methods described in the following embodiments are conventional methods unless otherwise specified.

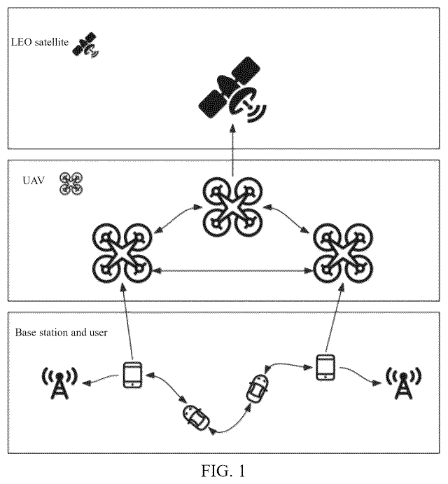

The present invention provides an adversarial learning-based optimization method for collaborative computing services in an integrated space-air-ground network. An edge mobile computing communication system in the integrated space-air-ground network is shown in FIG. 1. Assuming that the edge mobile computing communication system in the integrated space-air-ground network is composed of wireless devices, unmanned aerial vehicles, edge servers, and an LEO satellite, the objective of the system is to minimize total system delay under energy constraints of the wireless devices and the unmanned aerial vehicles.

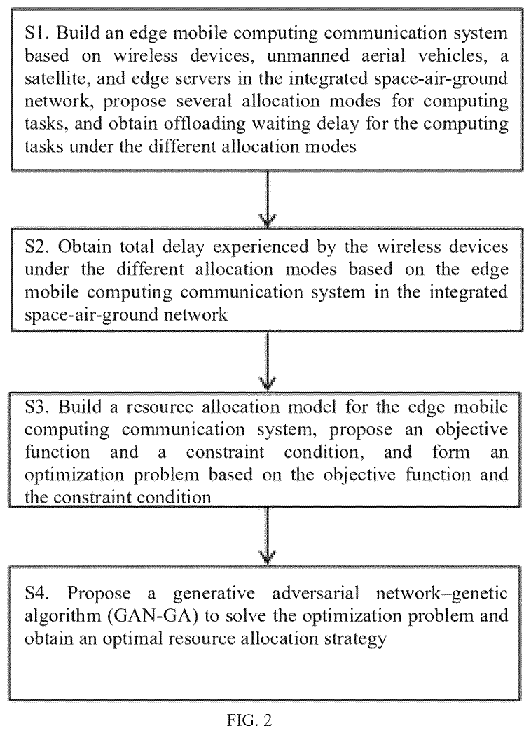

FIG. 2 is a flowchart of an adversarial learning-based optimization method for collaborative computing services in an integrated space-air-ground network according to an embodiment of the present invention. The method includes the following steps.

Step S1 specifically includes:
S11. Build an edge mobile computing communication system in the integrated space-air-ground network, including wireless devices, unmanned aerial vehicles, a satellite, and edge servers, and acquire data from the wireless devices, the unmanned aerial vehicles, the satellite, and the edge servers;
S12. Build task offloading decision variables to represent whether the computing task of the wireless device is completed locally or collaboratively computed with other terminals and servers;
S13. Compute offloading waiting delay and transmission energy consumption for the computing tasks under different allocation modes in the edge mobile computing communication system based on the task offloading decision variables and the data from the wireless devices, the unmanned aerial vehicles, the satellite, and the edge servers;
In a further embodiment, the edge mobile computing communication system in the integrated space-air-ground network is composed of wireless devices, unmanned aerial vehicles, edge servers, and an LEO satellite(S), where a set of wireless devices j is defined as J={1, 2, . . . , J}, a set of unmanned aerial vehicles k is defined as K={1, 2, . . . , K}, and a set of edge servers u is defined as U={1, 2, . . . , U}; and each wireless device j∈J in the considered network has a computing task Mⱼ, represented by Mⱼ=αⱼ+Aⱼ, where αⱼ represents a CPU cycle required to process one bit of data, and Aⱼ represents a total input data size of the task.
1. if the computing task Mⱼ is computed only in the wireless device j ent that the computing task Mⱼ is computed only locally:

$${w}_{j}^{loc} = \{ \begin{matrix}1 , & \text{?} {M}_{j} \text{?} j \text{?} \\ 0 , & otherwise\end{matrix}$$

where the wireless device first considers offloading the computing task to the nearest edge server u∈U.

$${w}_{j}^{u}$$

is defined as a task offloading decision variable:
1. if the computing task Mⱼ of the wireless device j is offloaded to the edge server u:

$$\text{?} 0 , otherwise .$$

Assuming that the distance between the wireless device j and the edge server u is

$${d}_{j}^{u} ,$$

a path loss model is expressed as:

$${P}_{u} ( {d}_{j}^{u} ) = {P}_{j} - 10 \cdot m \cdot {log}_{10} ( {d}_{j}^{u} ) + {G}_{j} + {G}_{u} , ∀ j ∈ {J}_{u} , u ∈ U$$

where Pⱼ represents a transmitting power at the wireless device j;

$${P}_{u} ( {d}_{j}^{u} )$$

represents a receiving power of the edge server u at the distance

$${d}_{j}^{u} ;$$

m represents a pain loss index; Gⱼ and Gᵤ represent gains of antennas at the wireless device j and the edge server u respectively; and Jᵤ represents a total set of wireless devices for collaborative computing with the edge server u.

An instantaneous data rate of the wireless device j is computed as follows:

$${γ}_{j}^{u} = {B}^{u} {log}_{2} ( 1 + \frac{{P}_{u} ( {d}_{j}^{u} ) {g}_{j}^{u}}{{I}_{j}^{u} + {σ}^{2}} ) , ∀ j ∈ {J}_{u} , u ∈ U$$

where σ² represents a noise power, Bᵤ represents an available bandwidth between the wireless device j and the edge server u,

$${g}_{j}^{u}$$

represents a channel gain between the wireless device j and the edge server u, and

$${I}_{j}^{u} = {\sum }_{\hat{j} ∈ J , \hat{j} \neq j} {\hat{w}}_{j}^{u} P ( {d}_{\hat{j}}^{u} ) {g}_{{j}^{′}}^{u} ,$$

represents interference at the edge server u.

An instantaneous data rate achieved by the wireless device j associated with the edge server u is as follows:

$${R}_{j}^{u} = \frac{{B}^{u}}{\vert {J}_{u} \vert} {γ}_{j}^{u} , {∀}_{j} ∈ {J}_{u} , u ∈ U$$

where |Jᵤ| represents a total number of wireless devices having computing tasks offloaded to the edge server u. According to the instantaneous data rate, the transmission delay experienced by the wireless device j when offloading its computing task to the edge server u is as follows:

$${t}_{j}^{u} = \frac{{A}_{j}}{{R}_{j}^{u}} , ∀ j ∈ {J}_{u} , u ∈ U$$

The energy consumption for task offloading from the wireless device j to the edge server u is as follows:

$${E}_{j}^{u} = \frac{{P}_{j} {A}_{j}}{{R}_{j}^{u}} , j ∈ {J}_{u} , k ∈ K$$

1. if the computing task Mⱼ of the wireless device j is offloaded to the UAV^{k} whether the task of the wireless device j is offloaded to the UAV k through a wireless link:

$${\overline{w}}_{j}^{k} = \{ \begin{matrix}1 , & \text{?} j \text{?} {M}_{j} \text{?} UAV k \\ 0 , & otherwise\end{matrix} .$$

[xⱼ, yⱼ]^{T} and [\tilde{x}ₖ, \tilde{y}ₖ]^{T} are defined as horizontal coordinates of the ground wireless device j and the UAV^{k}, where hₖ represents a hovering height of the UAV k over the ground, and the distance between the wireless device j and the UAV k is as follows:

$${d}_{j}^{k} = \sqrt{{( {x}_{j} - {x}_{k} )}^{2} + {( {y}_{j} - {y}_{k} )}^{2} + {h}_{k}^{2}} , ∀ j ∈ {J}_{k} , ∀ k ∈ K$$

where Jₖ represents a total set of wireless devices for collaborative computing between the wireless device j and the UAV k.

Then, by using a free space path loss model, a channel gain between the wireless device j and the UAV k is as follows:

$${g}_{j}^{k} = \frac{{g}_{0}}{{( {d}_{j}^{k} )}^{ϑ}} , ∀ j ∈ {J}_{k} , ∀ k ∈ K$$

where g₀ represents a channel gain at a reference distance d₀=1 m, and ϑ represents a path loss index. Therefore, according to Shannon's formula, a rate of the wireless device j is computed as follows:

$${γ}_{j}^{k} = {log}_{2} ( 1 + \frac{{P}_{j} {g}_{j}^{k}}{{I}_{j}^{k} + {σ}^{2}} ) , ∀ j ∈ {J}_{k} , ∀ k ∈ K$$

where Pⱼ represents an uplink transmission power of the wireless device j,

$${g}_{j}^{k}$$

represents an achievable channel gain between the wireless device j and the UAV k, σ² represents the noise power, and

$${I}_{j}^{k} = {\sum }_{{k}^{′} ∈ K , {k}^{′} \neq k} {\sum }_{{j}^{′} ∈ J , {j}^{′} \neq j} {w}_{j}^{k} {P}_{{j}^{′}} {g}_{{j}^{′}}^{k}$$

represents interference at the UAV k.

An instantaneous data rate achieved by the wireless device j associated with the UAV k is computed as follows:

$${R}_{j}^{k} = \frac{{B}^{k}}{\vert {J}_{k} \vert} {γ}_{j}^{k} , ∀ k ∈ K$$

where |Jₖ| represents a total number of wireless devices having computing tasks offloaded to the UAV k, and B^{k} represents an available bandwidth between the wireless device j and the UAV k. According to the instantaneous data rate, the transmission delay experienced by the wireless device j when offloading its computing task to the UAV k is as follows:

$${t}_{j}^{k} = \frac{{A}_{j}}{{R}_{j}^{k}} , ∀ j ∈ {J}_{k} , ∀ k ∈ K$$

The energy consumption for task offloading from the wireless device j to the UAV k is as follows:

$${E}_{j}^{k} = \frac{{P}_{j} {A}_{j}}{{R}_{j}^{k}} , j ∈ {J}_{k} , k ∈ K$$

1. if the computing task Mⱼ is offloaded from k to k′ m the related wireless device, the UAV k decides to process the task locally on its server or offload the task to the adjacent UAV or satellite, depending on its available computing capability. Define a binary decision variable

$${\tilde{w}}_{j}^{k \to {k}^{′}} ∈ \{ 0 , 1 \}$$

to represent whether the computing task Mⱼ is offloaded to the UAV k′, where the UAV k′ is nearest the UAV k:

$${\tilde{w}}_{j}^{k \to {k}^{′}} = \{ \begin{matrix}1 , \text{?} {M}_{j} \text{?} k \text{?} {k}^{′} \\ 0 , otherwise\end{matrix}$$

Assuming that there is a line-of-sight (LoS) communication link between unmanned aerial vehicles, an achievable channel gain between UAV k and UAV k′ is as follows:

Γ^{k→k′}=10^{L}^{^{k→k′}}^{/10}, ∀k,k′∈K
where L^{k→k′=} [symbol] ^{+ϑ}^{k→k′} represents a path loss between the unmanned aerial vehicles k and k′, where [symbol] represents an attenuation factor of the LoS link, and ϑ^{k→k′} is as follows:

$${ϑ}^{k \to {k}^{′}} = 20 {log}_{10} ( {d}_{k}^{{k}^{′}} ) + 20 {log}_{10} ( {f}_{c} ) + 10 {log}_{10} [ {( \frac{2 π}{c} )}^{2} ]$$

where f_{c} represents a carrier frequency, c represents a speed of light, and

$${d}_{k}^{{k}^{′}}$$

represents a distance between the unmanned aerial vehicles k and k′. Finally, compute an achievable data rate between the unmanned aerial vehicle k and k′:

$${R}_{j}^{k \to {k}^{′}} = {B}^{k \to {k}^{′}} {log}_{2} ( 1 + {Γ}^{k \to {k}^{′}} ) , ∀ k , {k}^{′} ∈ K$$

where B^{k→k′} represents an available bandwidth between UAV k and UAV k′.

The transmission delay between UAV k and UAV k′ is as follows:

$${t}_{j}^{k \to {k}^{′}} = \frac{{\sum }_{j ∈ {J}_{k}} {\tilde{w}}_{j}^{k \to {k}^{′}} {A}_{j}}{{R}^{k \to {k}^{′}}} , ∀ k , {k}^{′} ∈ K ,$$

The energy consumption for task offloading from UAV k to UAV k′ is as follows:

$${E}^{k \to {k}^{′}} = {P}^{k \to {k}^{′}} ( \frac{{\sum }_{j ∈ {J}_{k}} {\tilde{w}}_{j}^{k \to {k}^{′}} {A}_{j}}{{R}^{k \to {k}^{′}}} ) , ∀ k , {k}^{′} ∈ K$$

1. if the computing task Tⱼ is offloaded from the UAV^{k} to the satellite t the unmanned aerial vehicle k offloads the task to the satellite S:

$${\hat{w}}_{j}^{k \to s} = \{ \begin{matrix}1 , & \text{?} {T}_{j} \text{?} UAV k \text{?} \\ 0 , & otherwise\end{matrix}$$

An achievable signal-to-noise ratio between the unmanned aerial vehicle k and the satellite S is expressed as follows:

$${Γ}^{k \to s} = \frac{{P}^{k \to s} {g}_{k}^{tx} {g}_{s}^{rx} {L}_{r}}{{t}_{n} {aB}_{mm}^{k \to s}} {( \frac{c}{4 π {d}_{k}^{s} {f}_{c}^{mm}} )}^{2}$$

where P^{k→s} represents a transmitting power of the unmanned aerial vehicle k,

$${g}_{k}^{tx}$$

and

$${g}_{s}^{rx}$$

represents antenna gains of a transmitter an d a receiver, Lᵣ represents an attenuation factor, tₙ represents a noise temperature, a represents a Boltzmann constant,

$${f}_{c}^{mm}$$

represents a millimeter wave carrier frequency, and

$${d}_{k}^{s}$$

represents a distance between the unmanned aerial vehicle k and the satellite. An available millimeter wave backhaul capacity between the UAV k and the satellite is expressed as follows:

$${R}^{k \to s} = {B}_{mm}^{k \to s} {log}_{2} ( 1 + {Γ}^{k \to s} ) , ∀ k ∈ K$$

where

$${B}_{mm}^{k \to s}$$

represents a millimeter wave bandwidth between the UAV k and the satellite. Therefore, the transmission delay between the UAV k and the satellite is expressed as follows:

$${t}_{j}^{k \to s} = \frac{{\sum }_{j ∈ {J}_{k}} {\hat{w}}_{j}^{k \to s} {A}_{j}}{{R}^{k \to s}} , k ∈ K$$

The energy consumption for task offloading from the UAV k to the satellite is as follows:

$${E}^{k \to s} = {P}^{k \to s} ( \frac{{\sum }_{j ∈ {J}_{k}} {\hat{w}}_{j}^{k \to s} {A}_{j}}{{R}^{k \to s}} ) , ∀ k ∈ K$$

Step S2 specifically includes:
computing total delay and energy consumption experienced by the wireless devices under different allocation modes in the edge mobile computing communication system based on the task offloading decision variables and the data from the wireless devices, the unmanned aerial vehicles, the satellite, and the edge servers.

In a further embodiment, firstly, if the wireless device ∀j∈J decides to perform its computing task locally

$$( i . e . , {w}_{j}^{loc} = 0 ) ,$$

the delay experienced by the wireless device to complete the task is as follows:

$${t}_{j}^{loc} = \frac{{α}_{j} {A}_{j}}{{F}_{j}} , ∀ j ∈ J$$

where Fⱼ represents a computing power of the wireless device j (i.e., cycle/s). Then, the local energy consumption of the wireless device j is expressed as follows:

$${E}_{j}^{loc} = {{ϖ}_{j} ( {F}_{j} )}^{2} {α}_{j} {A}_{j} , j ∈ J$$

where ω̅ⱼ represents a constant that depends on a chip architecture of the wireless device.

When

$${\hat{w}}_{j}^{u} = 1 ,$$

the time required for the edge server u to complete the computing task is as follows:

$${t}_{j}^{u , comp} = \frac{{α}_{j} {A}_{j}}{{f}_{j}^{u}} , ∀ j ∈ {J}_{u}$$

where αⱼ represents a CPU cycle required to process one bit of data, and

$${f}_{j}^{u}$$

represents computing resources allocated to the edge server u of the wireless device j, formulated by a weighted proportional allocation formula as follows:

$${f}_{j}^{u} = {F}_{u}^{max} \frac{{α}_{j} {A}_{j}}{{\sum }_{∀ j ∈ J} {\hat{w}}_{j}^{u} {α}_{j} {A}_{j}} , ∀ j ∈ {J}_{u}$$

where

$${F}_{u}^{max}$$

represents a maximum computing power at the edge server u. The delay experienced by the wireless device j and the edge server u to collaboratively complete the computing task is as follows:

$${t}_{j}^{j , u} = {t}_{j}^{j \to u} + {t}_{j}^{u , comp} , ∀ j ∈ {J}_{u}$$

Secondly, if the task of the wireless device j is computed at the UAV k, the time required for the UAV k to complete the computing task is as follows:

$${t}_{j}^{k , loc} = \frac{{α}_{j} {A}_{j}}{{f}_{j}^{k}} , ∀ k ∈ K , ∀ j ∈ {J}_{k}$$

where

$${f}_{j}^{k}$$

represents a computing power of the UAV k that is allocated to the wireless device j, formulated by a weighted proportional allocation formula as follows:

$${f}_{j}^{k} = {F}_{k}^{max} \frac{{α}_{j} {A}_{j}}{{\sum }_{∀ j ∈ J} {\overline{w}}_{j}^{k} {α}_{j} {A}_{j}} , ∀ k ∈ K , ∀ j ∈ {J}_{k}$$

where

$${F}_{k}^{max}$$

represents a maximum computing power at the UAV k. Therefore, when

$${\overline{w}}_{j}^{k} = 1 ,$$

the total delay experienced by the wireless device j is expressed as follows:

$${t}_{j}^{k , e} = {t}_{j}^{k} + {t}_{j}^{k , comp} , ∀ k ∈ K , ∀ j ∈ {J}_{k}$$

Similarly, when

$${\tilde{w}}_{j}^{k \to {k}^{′}} = 1 ,$$

the total delay experienced by the wireless device j is expressed as follows:

$${t}_{j}^{{k}^{′} , e} = {t}_{j}^{k} + {t}_{j}^{k \to {k}^{′}} + {t}_{j}^{k , comp} , ∀ k ∈ K , ∀ j ∈ {J}_{k}$$

The energy consumption at the UAV k to perform the computing task Tⱼ is formulated as follows:

$${E}_{j}^{k , comp} = {{\overline{ω}}_{k} ( {f}_{j}^{k} )}^{2} {α}_{j} {A}_{j} , ∀ j ∈ J , ∀ k ∈ K ,$$

Finally, when the computing task of the wireless device j associated with the UAV k is completed on the satellite, the satellite has renewable energy, and the computational energy consumption of the satellite is ignored. Then, when the computing task of the wireless device j is offloaded to the satellite, the total execution delay experienced by the wireless device j is as follows:

$${l}_{j}^{k \to s , e} = {l}_{j}^{k} + {l}_{j}^{k \to s} + {l}_{j}^{s , comp} + 2 {l}_{j}^{k \to s , pro} , ∀ j ∈ {J}_{k} , k ∈ K ,$$

where

$${t}_{j}^{k \to s , pro} = \frac{{d}_{k}^{s}}{c}$$

represents propagation delay between the UAV k and the satellite.

Step S3 specifically includes:
building a resource allocation model for the edge mobile computing communication system based on an objective of minimizing the total delay experienced by the wireless device, and proposing an objective function about minimal total system delay while satisfying energy constraints of the wireless device and the unmanned aerial vehicle.

In a further embodiment, in order to minimize the total delay experienced by the wireless device while satisfying the energy constraints of the wireless device

$$( {E}_{j}^{max} )$$

and the unmanned aerial vehicle

$$( {E}_{k}^{max} ) ,$$

an optimization objective is defined as follows:

$${minimize}_{w} {\sum }_{j ∈ J} {T}_{j}$$

where w represents a binary variable of an association strategy, and Tⱼ represents the total system delay, specifically as follows:

$${T}_{j} = {w}_{j}^{loc} {t}_{j}^{loc} + {{w}^{⌢}}_{j}^{u} {t}_{j}^{j , u} + {\overline{w}}_{j}^{k} {t}_{j}^{j , k} + {\tilde{w}}_{j}^{k \to {k}^{′}} {t}_{j}^{{k}^{′} , e} + {w}_{j}^{k \to s} {t}_{j}^{j , k , s}$$

A constraint condition includes:

$${E}_{j}^{loc} + {E}_{j}^{k} + {E}_{j}^{u} \leq {E}_{j}^{max}$$

$${\sum }_{j ∈ J} {\overline{w}}_{j}^{k} {E}_{j}^{k , comp} + {\sum }_{{k}^{′} ∈ K , {k}^{′} \neq k} {E}_{j}^{k \to {k}^{′}} + {E}^{k \to s} + {E}_{k}^{hov} \leq {E}_{k}^{max} , ∀ k ∈ K$$

represents energy constraints of both the wireless device and the unmanned aerial vehicle.

$${w}_{j}^{loc} + {\overline{w}}_{j}^{k} + {{w}^{⌢}}_{j}^{u} + {\tilde{w}}_{j}^{k \to {k}^{′}} + {\hat{w}}_{j}^{k \to s} = 1 , ∀ j ∈ J$$

represents that the wireless device can select only one collaborative computing mode.

$${w}_{j}^{loc} , {{w}^{⌢}}_{j}^{u} , {\overline{w}}_{j}^{k} , {\tilde{w}}_{j}^{k \to {k}^{′}} , {\hat{w}}_{j}^{k \to s} ∈ \{ 0 , 1 \} , ∀ j , {j}^{′} ∈ J ,$$

∀k∈K, u∈U represents a binary decision variable of the wireless device.

$${E}_{j}^{u}$$

represents energy consumption for task offloading from the wireless device j to the edge server u,

$${E}_{j}^{k}$$

represents energy consumption for task offloading from the wireless device j to the UAV k, E^{k→k′} represents energy consumption for task offloading from the UAV k to the UAV k′, E^{k→s} represents energy consumption for task offloading from the UAV k to the satellite s,

$${E}_{k}^{hov}$$

represents energy consumption for hovering of the unmanned aerial vehicle, and

$${E}_{j}^{k , comp}$$

represents energy consumption when the UAV k performs the computing task Mⱼ.

Step S4 specifically includes:
S41. Build a generative adversarial network by using a GAN-GA algorithm based on the objective of minimal total system delay;
S42. Define an evaluation function based on the objective of minimal total system delay to compute a performance indicator and a fitness function;
S43. Select next-generation parent solutions and optimal solutions of a population by elite selection and roulette based on the objective of minimal total system delay and the fitness function;
S44. Initialize first-generation parent solutions, start evolution, use a generator for the generative adversarial network to replace conventional crossover and mutation operations in a genetic algorithm, and select the next-generation parent solutions;
S45. Repeat step S44 until the desired optimal solution of the system tends to stabilize.

Step S41 is specifically as follows:
The GAN needs to train two basic components: a generator and a discriminator. These components participate in a zero-sum game to generate real samples.

Generator: The main objective of the generator is to generate synthetic samples that are very similar to real data. Its function representation is G(z). It uses a random noise vector z sampled from distributed P_{z} as input and maps z to a data space, i.e., z~P_{z}(z). Its purpose is to ensure that G(z) is very similar to real data.

Discriminator: The discriminator serves as a binary classifier, and its function representation is D(x). It receives actual data x and the generated result G(z) as input. Its main objective is to distinguish samples generated by the generator and real data. It strives to make the output D(G(z)) close to 0 and the output D(x) close to 1.

An objective function of the discriminator is formulated as follows:

$${min}_{G} {max}_{D} {E}_{x \sim {P}_{data}} [ log ( D ( x ) ) ] + {E}_{x \sim {P}_{z}} [ log ( 1 - D ( G ( z ) ) ) ]$$

where x~P_{data} represents the distribution of real data. Through iterative training of the generator and the discriminator, when the discriminator fails to distinguish the real data and the generated results, the generator has successfully fooled the discriminator. This indicates that the generated results are closely consistent with the actual data distribution.

According to one aspect of the present application, step S42 is specifically as follows:

The evaluation function performs a series of complex computations on input sample features and generates an evaluation result.

The fitness function accepts the evaluation result of the evaluation function. Considering the given population j∈{1, 2, . . . , J}, the result value of the individual j that is generated by the evaluation function is Tⱼ. In the context of minimization problem, the fitness function is expressed as follows:

Oⱼ=Tₘₐₓ−Tⱼ+τ
where τ represents a very small real number used to ensure Oⱼ>0, and Tₘₐₓ represents a maximum tolerable delay of the task.

Step S43 specifically includes:
firstly, sorting the individuals according to the fitness function, selecting the top 20% individuals with the highest fitness as elite individuals, and determining selection probabilities of the remaining individuals based on their proportions of fitness in the population; then, randomly selecting the remaining individuals based on their probabilities to fill remaining selection gaps; and finally, merging the elite individuals with the individuals selected by roulette, and returning the selected next-generation parent solutions, indexes of the optimal solutions of the population, the fitness of the optimal solutions of the population, and the fitness of all the selected individuals.

Step S44 specifically includes:
initializing a parent population;
performing iterations, where each iteration includes the following steps:
generating offspring by using GAN,
merging the offspring with the parents,
decoding the merged population, that is, converting floating-point code into actual parameter values,
evaluating the performance of each individual, and
computing fitness; and
performing a selection operation to select a next-generation parent population, and recording optimal solutions and average solutions of the current generation;
where in each iteration, the GAN accepts the current parent population as input and generates a new offspring population.

Finally, it should be noted that the above descriptions are merely preferred embodiments of the present invention and are not intended to limit the present invention. Although the present invention is described in detail with reference to the foregoing embodiments, the technical solutions described in the foregoing embodiments can still be modified or some of them can be equivalently substituted by those skilled in the art. Any modification, equivalent replacement, or improvement made without departing from the spirit and principle of the present invention shall fall within the scope of protection of the present invention.

What is claimed is:

1. An adversarial learning-based optimization method for collaborative computing services in an integrated space-air-ground network, comprising the following steps:
S1: building an edge mobile computing communication system used for the collaborative computing services in the integrated space-air-ground network, wherein the edge mobile computing communication system is composed of wireless devices, unmanned aerial vehicles, edge servers, and a little earth orbit (LEO) satellite, wherein a quantity of the wireless devices is J, a set of the J wireless devices is defined as J={1, 2, . . . J}, a quantity of the unmanned aerial vehicles is K, a set of the K unmanned aerial vehicles is defined as K={1, 2, . . . , K} the unmanned aerial vehicle is abbreviated as UAV, a quantity of the edge servers is U, a set of the U edge servers is defined as U={1, 2, . . . , U} the LEO satellite is defined as s, and each of the wireless devices j∈J has a computing task Mⱼ proposing several allocation modes for the computing tasks, and obtaining offloading waiting delay and transmission energy consumption for the computing tasks under the different allocation modes based on the edge mobile computing communication system;
S2: obtaining total delay and energy consumption experienced by the wireless devices under the different allocation modes based on the edge mobile computing communication system;
S3: building a resource allocation model for the edge mobile computing communication system, proposing an objective function and a constraint condition, and forming an optimization problem based on the objective function and the constraint condition;
wherein energy constraints of the wireless device and the unmanned aerial vehicle are respectively
$${E}_{j}^{max} and {E}_{k}^{max} ;$$
an optimization objective is defined as
$${minimize}_{w} {\sum }_{j ∈ J} {T}_{j}$$
to minimize the total delay experienced by the wireless device while satisfying the energy constraints of the wireless device j and the unmanned aerial vehicle k;
wherein w represents a binary variable of an association strategy, and Tⱼ represents the total delay experienced by the wireless device j;
the constraint condition for the energy constraints of the wireless device j and the unmanned aerial vehicle k comprises:
$${E}_{j}^{loc} + {E}_{j}^{k} + {E}_{j}^{u} \leq {E}_{j}^{max} ,$$
$${\sum }_{j ∈ J} {\overline{w}}_{j}^{k} {E}_{j}^{k , comp} + {\sum }_{{k}^{′} ∈ K , {k}^{′} \neq k} {E}_{j}^{k \to {k}^{′}} + {E}^{k \to s} + {E}_{k}^{hov} \leq {E}_{k}^{max} , ∀ k ∈ K ;$$
wherein
$${E}_{j}^{u}$$
represents energy consumption for task offloading from the wireless device j to the edge server u,
$${E}_{j}^{k}$$
represents energy consumption for task offloading from the wireless device j to UAV k, E^{k→k′} represents energy consumption for task offloading from UAV k to UAV k′, E^{k→s} represents energy consumption for task offloading from UAV k to the satellite S,
$${E}_{k}^{hov}$$
represents energy consumption for hovering of the unmanned aerial vehicle, and
$${E}_{j}^{k , comp}$$
represents energy consumption when UAV k performs the computing task Mⱼ;
S4: performing the following operations:
S41: building a generative adversarial network by using a generative adversarial network-genetic algorithm (GAN-GA) algorithm to achieve minimal total system delay;
S42: defining an evaluation function based on an objective of minimal total system delay to compute a performance indicator and fitness;
S43: selecting next-generation parent solutions and optimal solutions of a population by elite selection and roulette selection based on the fitness;
S44: initializing first-generation parent solutions, starting evolution, using a generator for the generative adversarial network to replace conventional crossover and mutation operations in a genetic algorithm, and selecting the next-generation parent solutions; and
S45: finding optimal results through iterations.

2. The adversarial learning-based optimization method for the collaborative computing services in the integrated space-air-ground network according to claim 1, wherein S1 specifically comprises the following steps:
S11: acquiring data from the wireless devices, the unmanned aerial vehicles, the satellite, and the edge servers in the edge mobile computing communication system, wherein
each wireless device je J in the considered network has a computing task Mⱼ, represented by Mⱼ=αⱼ+Aⱼ, wherein αⱼ represents a central processing unit (CPU) cycle required to process one bit of data, and Aⱼ represents a total input data size of the task;
S12: building task offloading decision variables to represent whether the computing task of the wireless device is completed locally or collaboratively computed with other terminals and servers, comprising:
1. if the computing task Mⱼ is computed only in the wireless device j that the computing task Mⱼ is computed only locally:
$${w}_{j}^{loc} = \{ \begin{matrix}1 , \text{?} {M}_{j} \text{?} j \text{?} \\ 0 , otherwise\end{matrix}$$
1. if the computing task Mⱼ of the wireless device j is offloaded to the edge server u computing task Mⱼ is offloaded to the edge server u:
$${{w}^{}}_{j}^{u} = \{ \begin{matrix}1 , \text{?} {M}_{j} \text{?} \\ 0 , otherwise\end{matrix}$$
1. if the computing task Mⱼ of the wireless device j is offloaded to the UAV^{k} computing task Mⱼ is offloaded to the UAV k:
$${\overline{w}}_{j}^{k} = \{ \begin{matrix}1 , \text{?} {M}_{j} \text{?} \\ 0 , otherwise\end{matrix}$$
1. if the computing task Mⱼ is offloaded from UAV^{k} to UAV^{k′} ent whether the computing task Mⱼ is offloaded from the UAV k to UAV k′, wherein the UAV k′ is nearest the UAV k:
$${\tilde{w}}_{j}^{k \to {k}^{′}} = \{ \begin{matrix}1 , \text{?} {M}_{j} \text{?} UAVk \text{?} {UAVk}^{′} \\ 0 , otherwise\end{matrix}$$
defining a binary decision variable
$${\hat{w}}_{j}^{k \to s}$$
to represent that the UAV k offloads the task to the satellite s:
1. if the computing task Mⱼ is offloaded from the UAV^{k} to the satellite [symbol]
$$\text{?} υ , otherwise$$
S13: computing offloading waiting delay and transmission energy consumption for the computing tasks under different allocation modes in the edge mobile computing communication system based on the data from the wireless devices, the unmanned aerial vehicles, the satellite, and the edge servers, wherein
the communication rate from the wireless device j to the edge server u is
$${R}_{j}^{u} ,$$
the transmission delay experienced by the wireless device j when offloading its computing task to the edge server u is
$${t}_{j}^{u} = \frac{{A}_{j}}{{R}_{j}^{u}} ,$$
and the energy consumption for task offloading from the wireless device j to the edge server u is
$${E}_{j}^{u} = \frac{{P}_{j} {A}_{j}}{{R}_{j}^{u}} ;$$
wherein Pⱼ represents an uplink transmission power of the wireless device j;
the communication rate from the wireless device j to the UAV k is Rⱼ^{k}, the transmission delay experienced by the wireless device j when offloading its computing task to the UAV k is
$${t}_{j}^{k} = \frac{{A}_{j}}{{R}_{j}^{k}} ,$$
and the energy consumption for task offloading from the wireless device j to the UAV k is
$${E}_{j}^{k} = \frac{{P}_{j} {A}_{j}}{{R}_{j}^{k}} ;$$
the communication rate from the UAV k to the UAV k′ is R^{k→k′}, the transmission delay between the UAV k and the UAV k′ is
$${t}_{j}^{k \to {k}^{′}} = \frac{{\sum }_{j ∈ {J}_{k}} {\tilde{w}}_{j}^{k \to {k}^{′}} {A}_{j}}{{R}^{k \to {k}^{′}}} ,$$
and the energy consumption for task offloading from the UAV k to the UAV k′ is
$${E}_{j}^{k} = \frac{{P}_{j} {A}_{j}}{{R}_{j}^{k}} ,$$
wherein P^{k→k′} represents an uplink transmission power from the UAV k to the UAV k′, and Jₖ represents a total set of wireless devices for collaborative computing between the wireless device j and the UAV k;
the communication rate from the UAV k to the satellite is R^{k→s}, the transmission delay between the UAV k and the satellite is
$${t}_{j}^{k \to s} = \frac{{\sum }_{j ∈ {J}_{k}} {\hat{w}}_{j}^{k \to s} {A}_{j}}{{R}^{k \to s}} ,$$
and the energy consumption for task offloading from the UAV k to the satellite is
$${E}^{k \to s} = {P}^{k \to s} ( \frac{{\sum }_{j ∈ {J}_{k}} {\hat{w}}_{j}^{k \to s} {A}_{j}}{{R}^{k \to s}} ) ,$$
wherein P^{k→s} represents an uplink transmission power from the UAV k to the satellite.

3. The adversarial learning-based optimization method for the collaborative computing services in the integrated space-air-ground network according to claim 1, wherein S2 is specifically as follows:
if the wireless device ∀j∈J decides to perform its computing task locally
$$( i . e . , {w}_{j}^{loc} = 0 ) ,$$
the delay experienced by the wireless device to complete the task is as follows:
$${t}_{j}^{loc} = \frac{{α}_{j} {A}_{j}}{{F}_{j}} , ∀ j ∈ J$$
wherein F represents a computing power of the wireless device j (i.e., cycle/s); the local energy consumption of the wireless device j is expressed as follows:
$${E}_{j}^{loc} = {{\overline{ω}}_{j} ( {F}_{j} )}^{2} {α}_{j} {A}_{j} , j ∈ J$$
wherein ω̅ⱼ represents a constant that depends on a chip architecture of the wireless device;
when
$${\hat{w}}_{j}^{u} = 1 ,$$
the time required for the edge server u to complete the computing task is as
$${t}_{j}^{u , comp} = \frac{{α}_{j} {A}_{j}}{{f}_{j}^{u}} , ∀ j ∈ {J}_{u}$$
wherein αⱼ represents a CPU cycle required to process one bit of data, and
$${f}_{j}^{u}$$
represents computing resources allocated to the edge server u of the wireless device j, formulated by a weighted proportional allocation formula as follows:
$${f}_{j}^{u} = {F}_{u}^{max} \frac{{α}_{j} {A}_{j}}{{\sum }_{∀ j ∈ J} {\hat{w}}_{j}^{u} {α}_{j} {A}_{j}} , ∀ j ∈ {J}_{u}$$
wherein
$${F}_{u}^{max}$$
represents a maximum computing power at the edge server u; the delay experienced by the wireless device j and the edge server u to collaboratively complete the computing task is as follows:
$${t}_{j}^{j , u} = {t}_{j}^{j \to u} + {t}_{j}^{u , comp} , ∀ j ∈ {J}_{u}$$
if the task of the wireless device j is computed at the UAV k, the time required for the UAV k to complete the computing task is as follows:
$${t}_{j}^{k , loc} = \frac{{α}_{j} {A}_{j}}{{f}_{j}^{k}} , ∀ k ∈ K , ∀ j ∈ {J}_{k}$$
wherein
$${f}_{j}^{k}$$
represents a computing power of the UAV k that is allocated to the wireless device j, formulated by a weighted proportional allocation formula as follows:
$${f}_{j}^{k} = {F}_{k}^{max} \frac{{α}_{j} {A}_{j}}{{\sum }_{∀ j ∈ J} {\overline{w}}_{j}^{k} {α}_{j} {A}_{j}} , ∀ k ∈ K , ∀ j ∈ {J}_{k}$$
wherein
$${F}_{k}^{max}$$
represents a maximum computing power at the UAV k; therefore, when
$${\overline{w}}_{j}^{k} = 1 ,$$
the total delay experienced by the wireless device j is expressed as follows:
$${t}_{j}^{k , e} = {t}_{j}^{k} + {t}_{j}^{k , comp} , ∀ k ∈ K , ∀ j ∈ {J}_{k}$$
when
$${\tilde{w}}_{j}^{k \to {k}^{′}} = 1 ,$$
the total delay experienced by the wireless device j is expressed as follows:
$${t}_{j}^{{k}^{′} , e} = {t}_{j}^{k} + {t}_{j}^{k \to {k}^{′}} + {t}_{j}^{k , comp} , ∀ k ∈ K , ∀ j ∈ {J}_{k}$$
the energy consumption at the UAV k to perform the computing task Tⱼ is formulated as follows:
$${E}_{j}^{k , comp} = {{ϖ}_{k} ( {f}_{j}^{k} )}^{2} {α}_{j} {A}_{j} , ∀ j ∈ J , ∀ k ∈ K ,$$
when the computing task of the wireless device j associated with the UAV k is completed on the satellite, the satellite has renewable energy, and the computational energy consumption of the satellite is ignored; when the computing task of the wireless device j is offloaded to the satellite, the total execution delay by wireless device j is experienced the
$${l}_{j}^{k \to s , e} = {l}_{j}^{k} + {l}_{j}^{k \to s} + {l}_{j}^{s , comp} + 2 {l}_{j}^{k \to s , pro} , ∀ j ∈ {J}_{k} , k ∈ K , where {t}_{j}^{k \to s , pro} = \frac{{d}_{k}^{s}}{c}$$
represents propagation delay between the UAV k and the satellite.

4. The adversarial learning-based optimization method for the collaborative computing services in the integrated space-air-ground network according to claim 1, wherein S3 is specifically as follows:
$${w}_{j}^{loc} + {\overline{w}}_{j}^{k} + {\hat{w}}_{j}^{u} + {\tilde{w}}_{j}^{k \to {k}^{′}} + {\hat{w}}_{j}^{k \to s} = 1 ,$$
∀j∈J represents that the wireless device can select only computing mode; one collaborative
$${w}_{j}^{loc} , {\hat{w}}_{j}^{u} , {\overline{w}}_{j}^{k} , {\tilde{w}}_{j}^{k \to {k}^{′}} , {\hat{w}}_{j}^{k \to s} ∈ \{ 0 , 1 \} , ∀ j , {j}^{′} ∈ J ,$$
∀k∈K, u∈U represents a binary decision variable of the wireless device;
$${E}_{j}^{u}$$
represents energy consumption for task offloading from the wireless device j to the edge server u,
$${E}_{j}^{k}$$
represents energy consumption for task offloading from the wireless device j to the UAV k, E^{k→k′} represents energy consumption for task offloading from the UAV k to the UAV k′, E^{k→s} represents energy consumption for task offloading from the UAV k to the satellite s,
$${E}_{k}^{hov}$$
represents energy consumption for hovering of the unmanned aerial vehicle, and
$${E}_{j}^{k , comp}$$
represents energy consumption when the UAV k performs the computing task Mⱼ.

5. The adversarial learning-based optimization method for the collaborative computing services in the integrated space-air-ground network according to claim 1, wherein in S4,
S41 is specifically as follows:
the GAN trains a generator and a discriminator, and the generator and the discriminator participate in a zero-sum game to generate real samples;
the generator, with a function representation G(z), uses a random noise vector z sampled from distributed P_{z} as input and maps z to a data space, i.e., z~Pₓ(z);
the discriminator, as a binary classifier and with a function representation D(x), receives actual data x and the generated result G(z) as input; the discriminator strives to make the output D(G(z)) close to 0 and the output D(x) close to 1;
an objective function of the discriminator is formulated as follows:
$${min}_{G} {max}_{D} {E}_{x \sim {P}_{data}} [ log ( D ( x ) ) ] + {E}_{x \sim {P}_{z}} [ log ( 1 - D ( G ( z ) ) ) ]$$
wherein x~P_{data} represents the distribution of real data; through iterative training of the generator and the discriminator, when the discriminator fails to distinguish the real data and the generated results, the generator has successfully fooled the discriminator, and the generated results are closely consistent with the distribution of real data;
S42 is specifically as follows:
the evaluation function performs a series of complex computations on input sample features and generates an evaluation result;
the fitness function accepts the evaluation result of the evaluation function; considering the given population j∈{1, 2, . . . , J}, the result value of the individual j that is generated by the evaluation function is Tⱼ; in the context of minimization problem, the fitness function is expressed as follows:
Oⱼ=Tₘₐₓ−Tⱼ+τ
wherein τ represents a very small real number used to ensure Oⱼ>0, and Tₘₐₓ represents a maximum tolerable delay of the task;
S43 specifically comprises:
sorting the individuals according to the fitness function, selecting the top 20% individuals with the highest fitness as elite individuals, and determining selection probabilities of the remaining individuals based on their proportions of fitness in the population;
randomly selecting the remaining individuals based on their probabilities to fill remaining selection gaps; and
merging the elite individuals with the individuals selected by roulette, and returning the selected next-generation parent solutions, indexes of the optimal solutions of the population, the fitness of the optimal solutions of the population, and the fitness of all the selected individuals;
S44 specifically comprises:
initializing a parent population;
performing iterations, wherein each iteration comprises the following steps:
generating offspring by using GAN,
merging the offspring with the parents,
decoding the merged population, that is, converting floating-point code into actual parameter values,
evaluating the performance of each individual, and
computing fitness; and
performing a selection operation to select a next-generation parent population, and recording optimal solutions and average solutions of the current generation;
wherein in each iteration, the GAN accepts the current parent population as input and generates a new offspring population.
